(19) United States
(12) Patent Application Publication
(10) Pub. No.: US 2026/0192618 A1
(43) Pub. Date: Jul. 9, 2026

(54) FRONT AXLE OF A MOTOR VEHICLE AND MOTOR VEHICLE

(71) Applicant: AUDI AG, Ingolstadt (DE)

(72) Inventors: Maximilian MARGRAF, Möckenlohe (DE); David WÄSCHENBACH, Olpe (DE)

(73) Assignee: AUDI AG, Ingolstadt (DE)

(21) Appl. No.: 19/395,314

(22) Filed: Nov. 20, 2025

(30) Foreign Application Priority Data
Jan. 9, 2025 (DE) 102025100565.6

(51) Int. Cl. B60G 3/10; B60G 7/00; B60G 7/02; B60G 13/00; B62D 21/11; B62D 29/00

(52) U.S. Cl. CPC B60G 3/10; B60G 7/001; B60G 7/02; B60G 13/003; B62D 21/11; B60G 2200/1422; B60G 2200/156; B60G 2202/22; B60G 2202/24; B60G 2204/15; B60G 2204/16; B60G 2204/418; B60G 2206/124; B60G 2206/15; B62D 29/00

(57) ABSTRACT

A motor vehicle with two wheel suspensions, each with a control arm and a subframe. The control arms are each formed in a tension strut arrangement and have a tension strut, at least one wishbone and at least one steering bearing with a bearing axis. The subframe has longitudinal members in the vehicle longitudinal direction and at least one cross member in the vehicle transverse direction. The longitudinal members are rigidly connected to the at least one cross member in a connecting region. The wishbones are each mounted between the wheel suspension and a longitudinal member. The cross member has a central base region, which is perpendicular to the vehicle longitudinal direction and, at each end of the base region, a cantilever region formed obliquely forward with respect to the vehicle longitudinal direction.

### FIELD

The invention relates to a front axle of a motor vehicle, as well as to a motor vehicle.

### BACKGROUND

Small-overlap crash tests are an essential part of the safety testing of modern motor vehicles. These tests simulate a collision in which only a small portion of the front of the vehicle (about 25% or less) comes into contact with a rigid obstacle or barrier. Such scenarios often occur in real-life accidents, such as collisions with trees, lampposts, or the side of another vehicle. In contrast to central frontal crash tests, small-overlap crashes pose a significant technical challenge because the impact region is often outside the vehicle's primary load paths. This makes energy absorption more difficult, which can lead to reduced structural integrity and increased risk of injury.

A central problem is the barrier coverage. If the barrier's contact region covers only a small part of the front of the vehicle, many structurally critical components, such as longitudinal members, remain unused in the event of a collision. This leads to uncontrolled deformations and inefficient energy transfer. This is particularly critical for regions such as the A-pillar connection and the door structure, which are exposed to high loads in such impacts.

It is well known that in order to reduce the barrier overlap of a motor vehicle during a crash, various measures must be taken in the motor vehicle. For example, a widened subframe can be designed in front of the front steering bearing or additional mounting parts can be arranged on the subframe in order to enable early energy build-up and relieve the load on the passenger cell in the event of a crash with a small width overlap. However, these known measures have the disadvantage that the installation of additional components results in considerable additional costs. Furthermore, additional components require a very large installation space. This inevitably leads to an extended design of the motor vehicle.

Different concepts for reducing the risks in a small overlap crash are known from the prior art. In the event of a side impact, DE 10 2012 024 145 A1 provides for a wheel control arm to be displaced backwards by relocating a protective element against the direction of travel. This is intended to prevent the front wheels from turning and moving towards the bulkhead region—towards the center of the vehicle—in the event of an impact.

Furthermore, from DE 10 2018 208 784 A1 a deformation structure is known which has a strut and/or lever arrangement which, in the event of a frontal impact with complete width overlap, prevents penetration into the passenger cell by deformation and displacement of this strut and/or lever arrangement.

DE 10 2021 114 673 A1 describes a system in the region of the control arms and their connection to the subframe for controlling the wheel kinematics during a crash with a small width overlap.

DE 10 2021 132 464 A1 discloses a bearing arrangement of a wheel control arm on an axle carrier of the motor vehicle.

### SUMMARY

The object of the invention is to further develop a front axle for reducing the overlap of the motor vehicle, which in the event of a crash with a small width overlap enables early energy dissipation and at the same time ensures a compact vehicle design.

In a known manner, a front axle of a motor vehicle comprises two wheel suspensions, each with a control arm and a subframe. The control arms are each designed in a tension strut arrangement. The control arms each have a tension strut, at least one wishbone and at least one steering bearing. The tension strut is designed to transfer longitudinal forces and the wishbone is designed to transfer transverse forces into the vehicle structure. The tension strut and wishbone are each mounted on one side of the wheel suspension. The subframe has two longitudinal members in the vehicle's longitudinal direction and at least one cross member in the vehicle's transverse direction. The longitudinal members can be arranged parallel to each other. The longitudinal members are each rigidly connected to the at least one cross member in a connecting region. The wishbones are each mounted between the wheel suspension and a longitudinal axis.

According to the invention, the cross member has a central base region and, at each end of the base region, a cantilever region formed obliquely forward with respect to the longitudinal direction of the vehicle. The cross member is designed symmetrically with respect to an axis of symmetry that is oriented along the vehicle's longitudinal direction. The control arms are each mounted in an articulated manner on the cantilever region of the cross member by means of the steering bearings in the cantilever region. The free end of the cantilever region is formed with a barrier in a lateral extension within the region of the small lateral overlap of the motor vehicle. As a result, in the event of a crash with a small lateral overlap, the external force resulting from the crash is absorbed early on by the cantilever region of the cross member and the force flow is transferred via the connecting region directly to the longitudinal members via the support of the steering bearing arranged in the cantilever region via the bearing core. Due to the geometric design of the cantilever region and the support provided by the steering bearing and the tension strut, the force flow is reliably converted into transverse forces, which can cause a transverse displacement of the vehicle.

According to a further advantageous embodiment of the invention, the bearing axis of the steering bearing corresponds to the longitudinal axis of the cantilever region or the bearing axis of the steering bearing is formed parallel to the longitudinal axis of the cantilever region. This orientation of the bearing axis of the steering bearing ensures that in the event of a crash with small lateral overlap, a force flow is ensured parallel or along the bearing axis. This ensures ideal force transmission and avoids additional bending moments that can lead to deformation.

Preferably, the front steering bearing is designed as a hydraulic or hydraulically damped bearing. This allows vibrations such as starting torques, imbalances or the effects of external forces and torque peaks to be minimized.

Preferably, on the side of the longitudinal member facing away from the cantilever region, a support element is formed between the longitudinal member and the base region of the cross member. The support element is arranged diagonally between the longitudinal member and the base region of the cross member. By providing the support element, the force flow during a crash with a small width overlap is directed from the longitudinal member to the base region of the cross member. This enables even force distribution across the entire subframe and avoids one-sided loading.

According to a further advantageous embodiment of the invention, the cross member is formed from shell elements that are connected in a materially bonded manner. This ensures a simple structure of the cross member, which, due to its rigidity, is ideal for transmitting forces and thus contributes to the structural rigidity of the subframe.

The cross member is preferably made of steel or aluminum. Particularly preferably, the cross member has stiffening plates made of steel which are welded to the base body of the cross member in order to minimize deformation of the cross member and to ensure a better flow of forces to the longitudinal members in the region of the main load paths. The subframe, including the integrated cross member, can be made of aluminum to reduce weight.

Preferably, the longitudinal axis of the cantilever region is formed at an angle of greater than or equal to 20° and less than or equal to 80° to a transverse axis of the motor vehicle. A smaller angle leads to late energy dissipation and significant bending torques on the cross member. A larger angle results in a very high installation space requirement in the vehicle's longitudinal direction.

According to a further advantageous embodiment of the invention, the free end of the cantilever region is rounded. The rounding at the free end of the cantilever region of the cross member provides a sliding function for the cross member. The sliding function describes the ability of the subframe to guide the motor vehicle in such a way that it does not completely “immerse” itself in the barrier in the event of an impact. Instead, the vehicle should slide in a controlled direction to minimize deformation of the motor vehicle and the load on the passenger cell. Sharp edges on the cross member can concentrate stresses and lead to cracks or local deformations. Rounded shapes distribute forces more evenly and reduce the risk of structural failure.

A further aspect of the invention relates to a motor vehicle with a front axle, comprising two control arms, each with a steering bearing, a subframe, wherein the control arms are each designed in a tension strut arrangement, wherein the subframe has longitudinal members in the vehicle longitudinal direction and at least one cross member in the vehicle transverse direction, wherein the longitudinal members are each rigidly connected to the at least one cross member in a respective connection region.

According to the invention, the cross member is designed as described above.

Further advantages and possible uses of the invention will be apparent from the following description in conjunction with embodiments shown in the drawings.

### BRIEF DESCRIPTION OF THE FIGURE(S)

FIG. 1 shows a perspective view obliquely from the front of the front axle of a motor vehicle according to the invention.

### DETAILED DESCRIPTION

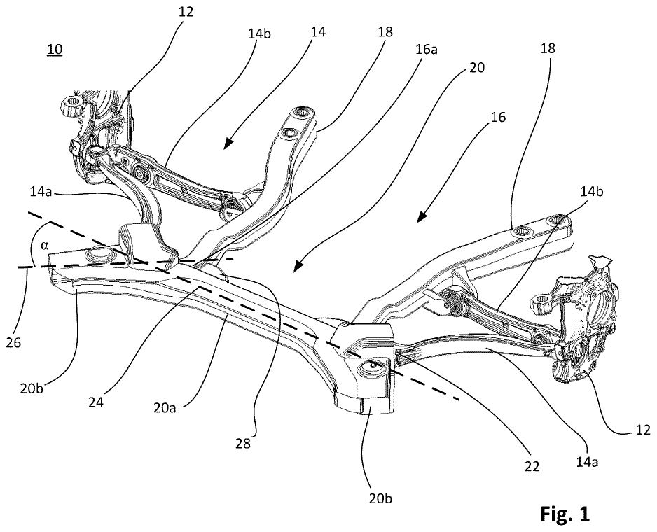

FIG. 1 shows a front axle 10 with two wheel suspensions 12, two control arms 14 and a subframe 16. The control arms 14 are mounted between the wheel suspensions 12 and the subframe 16 in an articulated manner. The front axle 10 is designed symmetrically, wherein the axis of symmetry is oriented along the vehicle longitudinal direction.

The subframe 16 has two longitudinal members 18 and one cross member 20. The longitudinal members 18 run in the vehicle longitudinal direction and the cross member 20 runs essentially in the vehicle transverse direction. At the front end of the longitudinal members 18 in the longitudinal direction of the vehicle, the longitudinal members 18 are rigidly connected to the cross member 20 in a connecting region 16a of the subframe 16. The cross member 20 and the longitudinal members 18 are each made of steel.

The cross member 20 has a base region 20a and a cantilever region 20b at each lateral end of the base region 20a. The base region 20a runs along a base region axis 24 and the cantilever region 20b runs along a cantilever region axis 26 obliquely forward with respect to the vehicle longitudinal axis. The base region axis 24 is oriented in the vehicle transverse direction. The base region axis 24 and the cantilever region axis 26 span an angle α. The angle α is greater than or equal to 20° and less than or equal to 80°.

The control arms 14 are designed in a tension strut arrangement and each have a tension strut 14a and a wishbone 14b. The wishbone 14b is mounted between the wheel suspension 12 and one of the longitudinal members 18. The tension strut 14a is mounted in an articulated manner with a steering bearing 22 between the wheel suspension 12 and the cantilever region 20b of the cross member 20. The steering bearing 22 is designed as a hydro bearing. The bearing core of the steering bearing 22 has a bearing axis. The bearing axis corresponds to the cantilever region axis 26. The bearing core can also be oriented so that the bearing axis is parallel to the cantilever region axis 26.

The cantilever region 20b is located within the region of the small lateral overlap of the motor vehicle relative to the barrier. In the event of a crash of the motor vehicle with a small lateral overlap, the external force resulting from the crash due to the motor vehicle hitting the barrier is absorbed early on by the cantilever region 20b of the cross member 20, which is oriented obliquely forward. The force flow then occurs from the cantilever region 20b via the bearing cores of the steering bearings and the connecting region 16a to the longitudinal members and as a transverse force component to the base region 20a. The acting force is also transmitted via the base region 20a to the side of the subframe 16 opposite the small lateral overlap. The resulting transverse forces can cause the vehicle to shift transversely.

The cantilever regions 20b each have a rounding at their free end. The rounding improves the sliding function of the cross member 20 in the region of the cantilever regions 20b.

The cross member 20 is formed from two half-shell elements which are rigidly connected to one another. Between the cross member 20 and a respective longitudinal member 18, a support element 28 is arranged or formed on the side of the longitudinal member 18 facing away from the cantilever region 20b, between the longitudinal member 18 and the base region 20a of the cross member 20.

The inventive design of the cross member 20 with the cantilever regions 20b extending obliquely forwards ensures early energy dissipation in the event of a crash with small lateral overlap. By supporting the cantilever region 20b via the steering bearing 22, the steering bearing 22 is integrated into the force flow and ensures an early conversion of the force into a transverse force, which is diverted across the entire subframe 16.

1. A front axle of a motor vehicle, comprising: two wheel suspensions, each with a control arm and a subframe, wherein the control arms are each designed in a tension strut arrangement and have a tension strut, at least one transverse arm and at least one steering bearing with a bearing axis, wherein the subframe has longitudinal members in the vehicle longitudinal direction and at least one cross member in the vehicle transverse direction, wherein the longitudinal members are each rigidly connected to the at least one cross member in a connecting region, and wherein the transverse arms are each mounted between the wheel suspension and a longitudinal member, wherein the cross member has a central base region running perpendicular to the vehicle longitudinal direction and, at one respective end of the base region, a cantilever region formed in an oblique forward direction relative to the vehicle's longitudinal direction, wherein the control arms are each mounted in an articulated manner on the cantilever region of the cross member by the steering bearings in the cantilever region, and wherein the free end of the cantilever region is formed with a barrier with a lateral extension within the region of the small lateral overlap of the motor vehicle.

2. The front axle of a motor vehicle according to claim 1, wherein the bearing axis of the steering bearing corresponds to the longitudinal axis of the cantilever region of the cross member or the bearing axis of the steering bearing is formed parallel to the longitudinal axis of the cantilever region.

3. The front axle of a motor vehicle according to claim 1, wherein the front steering bearing is designed as a hydraulically or hydraulically damped bearing.

4. The front axle of a motor vehicle according to claim 1, wherein on the side of the longitudinal member facing away from the cantilever region, a support element is formed between the longitudinal member and the base region of the cross member.

5. The front axle of a motor vehicle according to claim 1, wherein the cross member is formed as a unit from materially bonded shell elements.

6. The front axle of a motor vehicle according to a claim 1, wherein the cantilever region and base region are rigidly connected.

7. The front axle of a motor vehicle according to claim 1, wherein the cross member is made of steel or aluminum.

8. The front axle of a motor vehicle according to claim 1, wherein the longitudinal axis of the cantilever region is formed at an angle α of greater than or equal to 20° and less than or equal to 80° to a transverse axis of the motor vehicle.

9. The front axle of a motor vehicle according to claim 1, wherein the free end of the cantilever region is rounded.

10. A motor vehicle with a front axle, comprising: two control arms each with a steering bearing, a subframe, wherein the control arms are each designed in a tension strut arrangement, wherein the subframe has longitudinal members in the vehicle longitudinal direction and at least one cross member in the vehicle transverse direction, wherein the longitudinal members are each rigidly connected to the at least one cross member in a respective connection region, wherein the cross member is designed according to claim 1.

11. The front axle of a motor vehicle according to claim 2, wherein the front steering bearing is designed as a hydraulically or hydraulically damped bearing.

12. The front axle of a motor vehicle according to claim 2, wherein on the side of the longitudinal member facing away from the cantilever region, a support element is formed between the longitudinal member and the base region of the cross member.

13. The front axle of a motor vehicle according to claim 3, wherein on the side of the longitudinal member facing away from the cantilever region, a support element is formed between the longitudinal member and the base region of the cross member.

14. The front axle of a motor vehicle according to claim 2, wherein the cross member is formed as a unit from materially bonded shell elements.

15. The front axle of a motor vehicle according to claim 3, wherein the cross member is formed as a unit from materially bonded shell elements.

16. The front axle of a motor vehicle according to claim 4, wherein the cross member is formed as a unit from materially bonded shell elements.

17. The front axle of a motor vehicle according to a claim 2, wherein the cantilever region and base region are rigidly connected.

18. The front axle of a motor vehicle according to a claim 3, wherein the cantilever region and base region are rigidly connected.

19. The front axle of a motor vehicle according to a claim 4, wherein the cantilever region and base region are rigidly connected.

20. The front axle of a motor vehicle according to a claim 5, wherein the cantilever region and base region are rigidly connected.
